(19) United States
(12) Patent Application Publication
(10) Pub. No.: US 2015/0323313 A1
(43) Pub. Date: Nov. 12, 2015

(54) STRESS ANALYSIS OF SEMICONDUCTOR WAFERS

(71) Applicant: Applejack 199 L.P., San Jose, CA (US)

(72) Inventors: ARUN ANANTH AIYER, Fremont, CA (US); GUOGUANG LI, San Jose, CA (US)

(21) Appl. No.: 14/705,161

(22) Filed: May 6, 2015

Related U.S. Application Data
(60) Provisional application No. 61/989,478, filed on May 6, 2014.

(51) Int. Cl. G01B 11/24; G01N 21/95; G01B 11/06

(52) U.S. Cl. CPC G01B 11/2441; G01B 11/06; G01N 21/9505

(57) ABSTRACT

According to an aspect of an embodiment, a method may include measuring, based on interferometry, a film thickness of a surface film of a semiconductor wafer at a plurality of locations that are along a scanline of the wafer. The method may also include measuring, based on interferometry, a substrate thickness of a substrate of the semiconductor wafer at the plurality of locations. Moreover, the method may include measuring, based on an optical measurement technique, a curvature of the semiconductor wafer along the scanline. In addition, the method may include determining a stress of the surface film along the scanline based on the measured film thickness at the plurality of locations, based on the measured substrate thickness at the plurality of locations, and based on the measured curvature along the scanline.

### FIELD

The embodiments discussed in the present disclosure are related to stress analysis of semiconductor wafers.

### BACKGROUND

Integrated circuits are generally formed on semiconductor wafer substrates by a number of processing steps. These steps include deposition, etching, implantation, doping, and other semiconductor processing steps well known in the art.

Thin films are typically formed on wafer surfaces by a deposition process. These thin films may include, for example, silicon dioxide, AlSi, Ti, TiN, PECVD Oxide, PECVD Oxynitride, doped glasses, silicides, SiN etc.

Often it may be important to minimize or control Si stress induced by surface films. High surface stresses may cause, for example, silicide lifting, the formation of voids or crack and other conditions that may adversely affect semiconductor devices (e.g., integrated circuits) that may be fabricated on the wafers. In practice, surface stresses may become more problematical as the level of circuit integration increases, and may be especially troublesome when fabricating large scale integration (LSI), very large scale integration (VLSI), and ultra large scale integration (ULSI) semiconductor devices.

The stress in the surface film of a semiconductor wafer may be either compressive or tensile. A compressive stress in a surface film may cause a wafer to slightly bow in a convex direction, while a tensile stress in a surface film may cause a wafer to slightly bow in a concave direction. Therefore, both compressive and tensile stresses may cause the surface of the semiconductor wafer to deviate from exact planarity. The extent of the deviation from planarity may be expressed in terms of the radius of curvature of a wafer surface.

Because of the problems that may be caused by stresses by surface films on semiconductor wafers, it may be desirable to be able to measure such stresses. The measurements may be used, for example, to identify wafers that are likely to provide low yields of semiconductor devices or which may produce semiconductor devices prone to early failure.

In mathematical terms, surface film stresses are often expressed by a function that includes Young's modulus for the silicon substrate portion of the wafer, the Poisson ratio for the substrate, the thickness of the substrate, the film thickness, and the radius of curvature of the wafer due to surface film stress. As a matter of convention, negative values of a radius of curvature indicate compressive stress and positive values indicate tensile stress.

The subject matter claimed herein is not limited to embodiments that solve any disadvantages or that operate only in environments such as those described above. Rather, this background is only provided to illustrate one example technology area where some embodiments described herein may be practiced.

### SUMMARY

According to an aspect of an embodiment, a method may include measuring, based on interferometry, a film thickness of a surface film of a semiconductor wafer at a plurality of locations that are along a scanline of the wafer. The method may also include measuring, based on interferometry, a substrate thickness of a substrate of the semiconductor wafer at the plurality of locations. Moreover, the method may include measuring, based on an optical measurement technique, a curvature of the semiconductor wafer along the scanline. In addition, the method may include determining a stress of the surface film along the scanline based on the measured film thickness at the plurality of locations, based on the measured substrate thickness at the plurality of locations, and based on the measured curvature along the scanline.

The object and advantages of the embodiments will be realized and achieved at least by the elements, features, and combinations particularly pointed out in the claims.

Both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1A is a diagram representing an example wafer measurement device configured to determine stresses with respect to a semiconductor wafer;

FIG. 1B illustrates an example scanline of the semiconductor wafer of FIG. 1A;

FIG. 1C illustrates an example pattern of the semiconductor wafer of FIGS. 1A and 1B where thicknesses may be measured;

FIG. 2 is a flowchart of an example method of determining film stress of a semiconductor wafer; and

FIG. 3 is a flowchart of an example method of detecting an irregular portion of a semiconductor wafer.

### DESCRIPTION OF EMBODIMENTS

As disclosed in detail below, the present disclosure relates to systems and methods for determining stresses of semiconductor (e.g., silicon) wafers. In particular, stress of a surface film (“film stress”) of a semiconductor wafer may be determined along one or more scanlines of the semiconductor wafer. The film stress may be determined based on a thickness of the film (“film thickness”) along the scanline, on the thickness of a substrate of the semiconductor wafer (“substrate thickness”), and on curvature of the semiconductor wafer along the scanlines.

In some embodiments described in the present disclosure, a wafer measurement device may be configured to measure the film thickness and the substrate thickness of the wafer at one or more locations along the scanlines. The film thickness measurements and the substrate thickness measurements may be referred to collectively or individually with the general term “thickness measurements” in the present disclosure. Similarly, the film thickness and the substrate thickness may be referred to collectively or individually with the general term “thicknesses” in the present disclosure. Additionally, the wafer measurement device may be configured to measure the curvature of the semiconductor wafer along the scanlines. The wafer measurement device may be configured to determine a corresponding film stress along each of the scanlines based on the corresponding thickness and curvature measurements for the scanlines.

In contrast, many other systems and devices that determine stress of films of semiconductor wafers either do so based on average thickness estimations associated with the semiconductor wafer as a whole, average curvature estimations associated with the semiconductor wafer as a whole, or both average thickness estimations and average curvature estimations. However, semiconductor wafer surfaces may be fairly irregular such that average thickness estimations or average curvature estimations may be substantially inaccurate with respect to a particular scanline of a semiconductor wafer. Consequently, the wafer measurement device and corresponding methods used to determine stress that are disclosed in the present disclosure may provide a better and more accurate stress determination of semiconductor wafers than other systems and methods that are in use.

Embodiments of the present disclosure are explained with reference to the accompanying drawings.

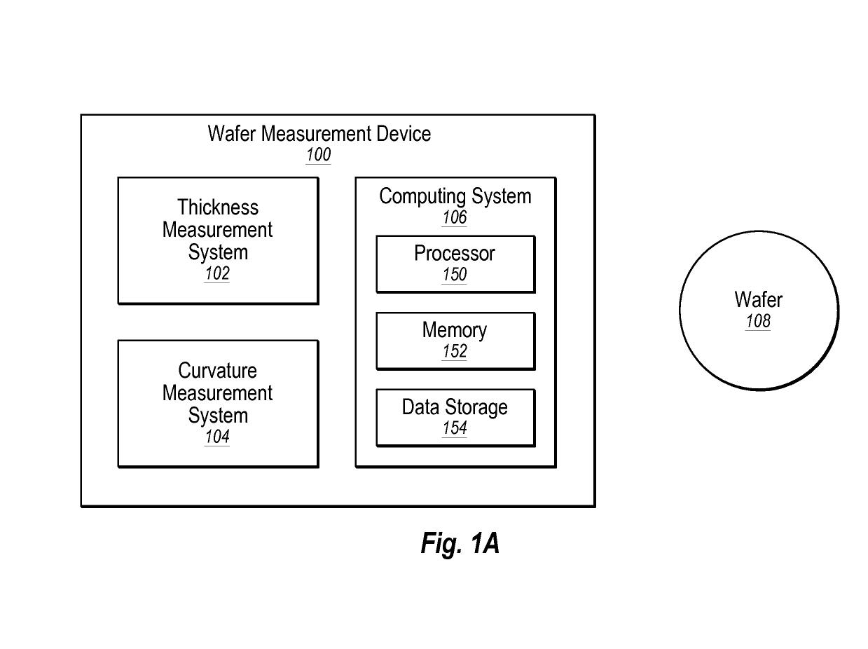

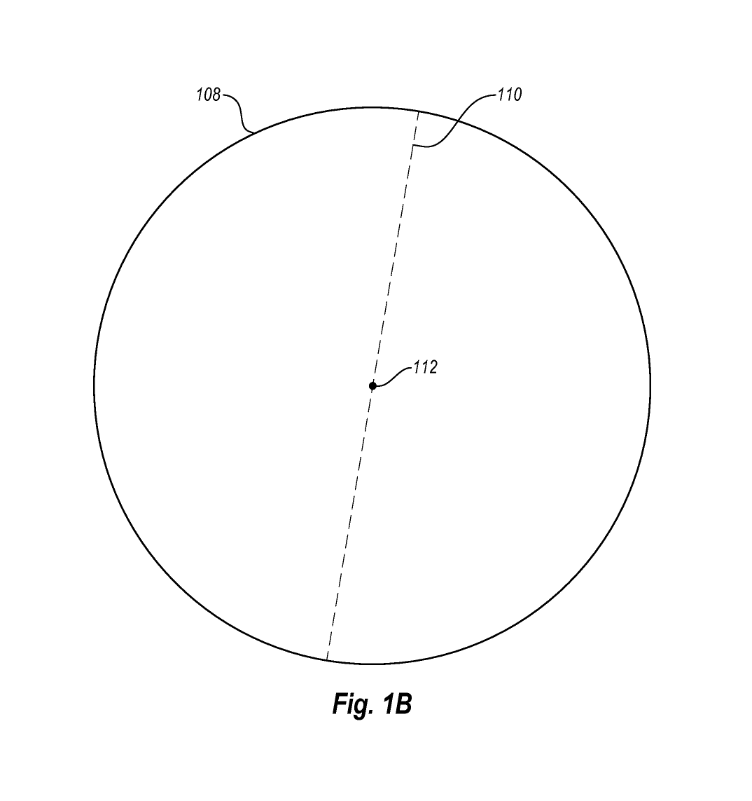

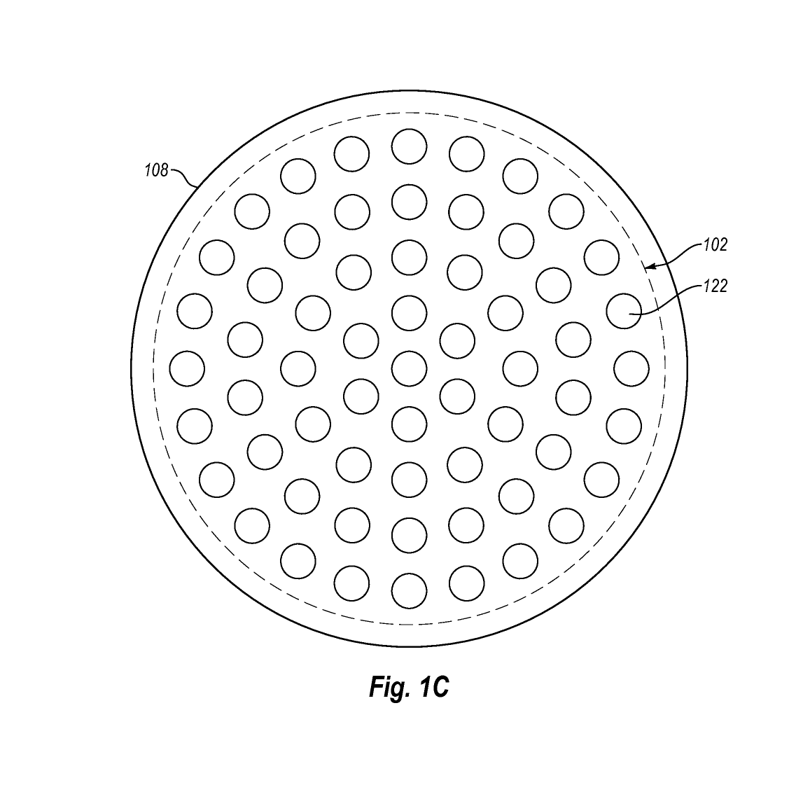

FIG. 1A is a diagram representing an example wafer measurement device 100 (“device 100”) configured to determine stresses with respect to a semiconductor wafer (“wafer”) 108, arranged according to at least one embodiment of the present disclosure. The device 100 may include a thickness measurement system 102, a curvature measurement system 104, and a computing system 106.

The computing system 106 may include a processor 150, a memory 152, and a data storage 154. The processor 150, the memory 152, and the data storage 154 may be communicatively coupled. The computing system 106 may be configured to perform or cause the device 100 to perform one or more operations related to determining stresses with respect to the wafer 108. In some embodiments, the computing system 106 may direct or cause the thickness measurement system 102 and/or the curvature measurement system 104 to perform their respective operations, which are described below.

Further, in some parts of the present disclosure, the thickness measurement system 102 and the curvature measurement system 104 are described as measuring thickness and curvature, respectively. In some embodiments, the computing system 106 may be configured to perform or may direct the performance of one or more operations and/or calculations that may be used to measure thickness or curvature. As such, reference to the thickness measurement system 102 and/or the curvature measurement system 104 “measuring” thickness or curvature may also refer to operations and/or calculations that may be performed by or directed for performance by the computing system 106 with respect to determining thickness or curvature based on measurements that may be performed by the thickness measurement system 102 and the curvature measurement system 104, respectively.

In general, the processor 150 may include any suitable special-purpose or general-purpose computer, computing entity, or processing device including various computer hardware or software modules and may be configured to execute instructions stored on any applicable computer-readable storage media. For example, the processor 150 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in FIG. 1, the processor 150 may include any number of processors configured to perform, individually or collectively, any number of operations described in the present disclosure. Additionally, one or more of the processors may be present on one or more different electronic devices, such as different servers.

In some embodiments, the processor 150 may interpret and/or execute program instructions and/or process data stored in the memory 152, the data storage 154, or the memory 152 and the data storage 154. In some embodiments, the processor 150 may fetch program instructions from the data storage 154 and load the program instructions in the memory 152. After the program instructions may be loaded into memory 152, the processor 150 may execute the program instructions.

For example, in some embodiments, the analysis module may be included in the data storage 154 as program instructions. The processor 150 may fetch the program instructions of the analysis module from the data storage 154 and may load the program instructions of the analysis module in the memory 152. After the program instructions of the analysis module are loaded into memory 152, the processor 150 may execute the program instructions such that the computing system may implement the operations associated with the analysis module as directed by the instructions.

The memory 152 and the data storage 154 may include computer-readable storage media for carrying or having computer-executable instructions or data structures stored thereon. Such computer-readable storage media may include any available media that may be accessed by a general-purpose or special-purpose computer, such as the processor 150. By way of example, and not limitation, such computer-readable storage media may include tangible or non-transitory computer-readable storage media including RAM, ROM, EEPROM, CD-ROM or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 150 to perform a certain operation or group of operations.

The curvature measurement system 104 may include any suitable system, apparatus, or device that may be configured to measure curvature of a semiconductor wafer. In some embodiments, the curvature measurement system 104 may be configured to measure the curvature based on any suitable optical measurement technique.

For example, in some embodiments, the curvature measurement system 104 may be configured to measure the curvature based on laser triangulation. In particular, in some embodiments, the curvature measurement system 104 may be configured to direct light (e.g., a laser beam) toward a surface of the wafer 108 and the light may be deflected by the surface of the wafer 108. The curvature measurement system 104 may include a mirror that may be configured to reflect the deflected light toward a position sensitive photodetector (PSD) that may detect the deflected light. The curvature measurement system 104 may be configured to scan along the surface of the wafer 108 and the deflected light detection may be performed for many (e.g., thousands) of points with respect to the scan.

In some embodiments, the surface of the wafer 108 may be scanned prior to film deposition and then may be scanned after film deposition. The data from the scans may be compared and a radius of curvature may be determined from the slope of a straight line that is fitted to point by point subtraction data that may be calculated from the before and after deposition scan data.

In some embodiments, the curvature measurement system 104 may be implemented based on one or more systems and methods described with respect to U.S. Pat. No. 5,233,201 issued on Aug. 3, 1993 and entitled “SYSTEM FOR MEASURING RADII OF CURVATURES” and U.S. Pat. No. 5,270,560 issued on and Dec. 14, 1993 and entitled “METHOD AND APPARATUS FOR MEASURING WORKPIECE SURFACE TOPOGRAPHY,” the entire contents of both being incorporated by reference in the present disclosure in their entirety.

In some embodiments, the curvature measurement system 104 may be configured to measure the curvature along one or more scanlines of the wafer 108. As indicated further below, the curvature along the scanlines may be used to determine surface film stresses that may be present along the scanlines.

In some instances, the scanlines may run parallel to the surface of the wafer 108 and in some embodiments may run such that they may substantially intersect a center of the wafer 108. The scanlines may indicate a portion of the wafer 108 along which the curvature of the wafer 108 may be determined. The scanlines may not be actual physical lines but instead may indicate a path along which the curvature measurement system 104 may measure the curvature of the wafer 108.

In some embodiments, the curvature measurement system 104 may be configured to measure the curvature of the wafer 108 along an entire scanline. Further, in some instances, the curvature may vary along one or more scanlines. As such, in these or other embodiments, the curvature measurement system 104 may be configured to determine the curvature of the wafer 108 along one or more subsections of a scanline.

Additionally or alternatively, the curvature measurement system 104 may be configured to measure the curvature along multiple scanlines that may be rotated along the wafer 108 with respect to each other. The spacing and number of the scanlines may be such that a relatively comprehensive determination of curvature with respect to the wafer 108 as a whole may be made.

For example, the curvature measurement system 104 may be configured to determine the curvature of the wafer 108 along thirty-two (32) different scanlines of the wafer 108 that may be spaced approximately 5.625° apart. In these or other embodiments, any suitable interpolation technique may be made with respect to the curvature measurements along the 32 different scanlines to generate a curvature map that may indicate curvature with respect to the wafer 108 as a whole. The number of scanlines and corresponding spacing in the above example are merely that, examples, and are not limiting.

FIG. 1B illustrates an example scanline 110 of the wafer 108, according to at least one embodiment of the present disclosure. The scanline 110 may run parallel to a surface of the wafer 108 and may intersect a center 112 of the wafer 108. The scanline 110 is merely an example scanline and in some instances thickness and curvature measurements may be made alone one or more other scanlines than illustrated. Additionally, the location of the scanline 110 with respect to the wafer 108 is merely an example.

The thickness measurement system 102 may include any suitable system, apparatus, or device that may be configured to measure film thickness of a film of the wafer 108. Additionally or alternatively, the thickness measurement system 102 may be configured to measure substrate thickness of a substrate of the wafer 108. In some embodiments, the thickness measurement system 102 may be configured to measure the thickness based on interferometry.

For example, in some embodiments, the thickness measurement system 102 may be configured to generate and direct light within a certain spectrum toward a portion of the wafer 108. The spectrum may be selected based on which wavelengths of light may pass through the material whose thickness may be measured. For example, the spectrum may be within the near infrared range (e.g., 900 nm to 1700 nm) for measuring substrate thickness and the spectrum may be within a visible light range or within a NIR range (e.g., 300 nm to 1000 nm and 900 nm to 1700 nm) for measuring film thickness.

A first portion of the light may be reflected by the substrate or film of the wafer 108. A second portion of the light may pass through at least a portion of the substrate or film and may then be reflected back out of the wafer 108 at the surface at which the second portion may have entered the wafer 108. The thickness measurement system 102 may be configured such that the first portion and the second portion may be combined and may be directed toward a spectrometer of the thickness measurement system 102.

The spectrometer may be configured to receive the combined first and second portions and may be configured to separate the combined first and second portions into different wavelengths of the spectrum of the light directed toward the wafer 108. The spectrometer may also be configured to measure the intensity of the combined first and second portions at the different wavelengths such that the intensity of the combined first and second portions of light over the spectrum may be measured. The intensities of the different wavelengths may vary based on phase differences between the first and second portions at the respective wavelengths. The phase differences may be due to distances traveled by the first and second portions, which may be based on the thickness of the material being measured. As such, the intensities of the different wavelengths may be based on the thickness.

In some embodiments, the spectrometer may be communicatively coupled to the computing system 106 and may be configured to communicate the intensities of the wavelengths over the corresponding spectrum to the computing system 106. In some embodiments, the computing system 106 may be configured to perform a Fourier Transformation on the measured intensity over the spectrum of the different wavelengths. The Fourier Transformation may transform the data from the frequency domain to the distance domain such that the intensity of the combined first and second portions may be represented along an area of the portion of the wafer 108 that the light may be directed toward. The intensity in the distance domain may be used to determine the corresponding thickness using any suitable and known calculation. In some embodiments, the Fourier Transform may be performed as a Fast Fourier Transform (FFT).

In these or other embodiments, the computing system 106 may be configured to perform mod based algorithm (MBA)) calculations to determine film and/or substrate thickness. In MBA, layer stacks, e.g., substrate and over-layer film(s) may be modeled using characteristic matrices where each matrix may represent one layer in the stack. This model may predict spectral response of the stack. Using regression analysis, the thickness values that generate the spectrum with highest correlation to the measured spectrum may be the substrate and film thicknesses.

In some embodiments, the thickness measurement system 102 may be implemented based on one or more auto-correlation systems and methods described with respect to U.S. patent application Ser. Nos. 14/260,054 and 12/931,566 respectively filed on Feb. 4, 2011 and Apr. 23, 2014 and both entitled “METHOD AND SYSTEM FOR MEASURING PATTERNED SUBSTRATES,” the entire contents of both being incorporated by reference in the present disclosure in their entirety.

In some embodiments, the thickness measurement system 102 may be configured to measure the thicknesses at one or more locations of the wafer 108. The locations may be in a pattern that may cover different portions of the wafer 108 to determine the thicknesses over a distributed area of the wafer 108 in some embodiments. For example, FIG. 1C illustrates an example pattern 120 that may include sixty (60) locations 122 of the wafer 108 where the thicknesses may be measured. As illustrated in FIG. 1C, the locations 122 may be distributed among the wafer 108 to provide indications of the thicknesses across a substantial portion of the wafer 108.

Additionally or alternatively, the thickness measurement system 102 may be configured to measure the thicknesses at one or more locations along the scanlines. For example, in some embodiments, the thickness measurement system 102 may be configured to measure the thicknesses at one or more locations along the scanline 110 of FIG. 1B.

As indicated further below, in some embodiments, the thickness measurements may be used to determine surface film stresses that may be along the respective scanlines. Accordingly, in some embodiments, the thickness measurement system 102 may be configured to determine the thickness measurements at one or more locations along a respective scanline (e.g., along the scanline 110) according to a position of the respective scanline. As such, the thickness measurements may be made at the locations based on the locations being along the respective scanline.

In these or other embodiments, the thickness measurement system 102 may be configured to measure the thicknesses according to a specified pattern (e.g., according to the pattern 120 of FIG. 1C). The measured thicknesses at one or more of the locations of the pattern that may intersect the corresponding scanline may be used to determine surface film stresses that may be along the corresponding scanline. For example, the thickness measurements at the locations 122 of FIG. 1C that may intersect the scanline 110 of FIG. 1B may be used to determine surface film stresses long the scanline 110.

In some embodiments, one or more of the thickness measurements may be averaged and the averaged thickness measurements may be used for determining the surface film stresses. For example, in some embodiments, the thicknesses measured at all the locations 122 of FIG. 1C may be averaged and the resulting average may be used in the surface film stress calculations. Additionally or alternatively, the thicknesses measured at locations along a particular scanline may be averaged and the resulting average may be used in the surface film stress calculations that correspond to the particular scanline.

In some embodiments, the wafer 108 may include a patterned semiconductor wafer in which the film may be deposited on the wafer 108 and patterned according to a particular pattern. The particular pattern may include gridlines that may correspond to where the film may be deposited and where the film may not be deposited. Film thickness measurements at the gridlines and where the film may not be present may be inaccurate. Additionally, in some instances, the wafer 108 may include a rough surface in which portions of the wafer 108 may scatter light in a manner that may not allow for accurate thickness measurements. Portions of the wafer 108 that may scatter light may be referred to as “scatter portions.” Additionally, portions of the wafer 108 that may not have film deposited thereon may be referred to as “substrate portions.”

Therefore, in some embodiments, the device 100 may be configured to detect gridlines, scatter portions, substrate portions, or any combination thereof. The device 100 may be configured to determine locations at which to measure thicknesses that may not be positioned at gridlines based on the gridline detection. In these or other embodiments, the device 100 may be configured to determine locations at which to measure film thickness that may not be positioned at substrate portions based on the substrate portion detection. Additionally or alternatively, the device 100 may be configured to determine locations at which to measure thicknesses that may not be positioned at scatter portions based on the scatter portion detection.

In some embodiments, the device 100 may be configured to detect the gridlines and/or the substrate portions based on a comparison of a threshold film signal strength and a film signal strength associated with a particular portion of the wafer 108 (e.g., a particular location 122 of the wafer 108) where the film thickness may be measured.

For example, the thickness measurement system 102 may measure, in the frequency domain and across a corresponding spectrum, an intensity of light that may reflect off the particular portion of the wafer 108 during a film thickness measurement of the particular portion of the wafer 108. The light that may reflect off the wafer 108 may include first and second portions of light such as the first and second portions described above.

The computing system 106 may be configured to perform an FFT on the measured intensity to transform the measured intensity from the frequency domain to the distance domain. The intensity in the distance domain may form a curve of the intensity of the reflected light with respect to different film thicknesses. The curve may be referred to as the “distance domain curve.” In some embodiments, the computing system 106 may be configured to determine a peak intensity of the distance domain curve using any suitable method or process.

In these or other embodiments, the computing system 106 may be configured to determine an area under the distance domain curve and the area under the distance domain curve may be used as the signal power. In some embodiments, the computing system 106 may be configured to determine the area under the entire distance domain curve and may use such area as the film signal strength.

Additionally or alternatively, the computing system 106 may be configured to determine the area under a portion of the distance domain curve and may use the area under the portion of the distance domain curve as the film signal strength. For example, the computing system 106 may be configured to determine the area under the distance domain curve where the intensity is greater than 50% of the peak intensity. As another example, the computing system 106 may be configured to determine the area under the distance domain curve where the intensity is greater than 80% of the peak intensity. The percentages given are mere examples such that different percentages may be used. Note that as less of the area is determined (e.g., area where the intensity is greater than 80% as opposed to area where the intensity is greater than 50%) the speed of the determination may be increased, but the accuracy may be decreased.

In these or other embodiments, the computing system 106 may be configured to compare the determined film signal strength with the threshold film signal strength. The computing system 106 may be configured to determine that the particular portion may include one or more gridlines or may include a substrate portion in response to the determined film signal strength not satisfying (e.g., being less than) the threshold film signal strength.

The threshold film signal strength may be determined based on a previously measured film signal strength with respect to a substrate portion or a portion that includes a gridline. Additionally, the threshold film signal strength may be determined based on how the film signal strength may be measured. For instance, the threshold film signal strength may have a different value with respect to a first film signal strength determined based on the entire area under the distance domain curve than with respect to a second film signal strength determined based on the area under the distance domain curve where the intensity is greater than 50%.

Additionally, or alternatively the film and substrate thickness may be determined using MBA approach wherein the thicknesses values may be arrived at based on the highest possible correlation between MBA predicted spectrum and measured spectrum.

The above example is given with respect to detecting substrate portions and/or gridlines. However, the same principles may apply with respect to detecting one or more scatter portions of the wafer 108. The differences may merely be in which intensity measurements (e.g., intensity measurements for substrate thickness determining or film thickness determining) may be used and which threshold signal strengths may be used depending on the intensity measurements. Further, the above description of determining signal strength is merely an example. Other techniques may be used to determine signal strength and the determined signal strength of a particular technique may be compared with a threshold that may be based on the particular technique.

In some embodiments, when performing film thickness measurements with respect to patterned wafers, the computing system 106 may be configured to automatically make a determination as to whether or not the film thickness measurements are made on portions that include gridlines or substrate portions. In these or other embodiments, the computing system 106 may direct that a film thickness measurement be made at a different portion in response to a determination that a particular film thickness measurement is made on a particular portion that includes gridlines or a substrate portion. As such, the computing system 106 may be configured such that the film thickness may not be measured at the substrate portions or at the gridlines.

Additionally or alternatively, the computing system 106 may be configured to automatically make a determination as to whether or not the film or substrate thickness measurements are made on portions that include scatter portions. In these or other embodiments, the computing system 106 may direct that a corresponding film thickness measurement and/or substrate thickness measurement be made at a different portion in response to a determination that a corresponding particular film thickness measurement and/or substrate thickness measurement is made on a particular portion that includes a scatter portion. As such, the computing system 106 may be configured such that the film thickness and/or the substrate thickness may not be measured at the scatter portions.

In some embodiments, the computing system 106 may be configured to determine film stresses along one or more of the scanlines based on the thickness measurements and the curvature measurements that may correspond to the scanlines according to any suitable method or process. For example, film stress may affect the curvature of the wafer 108 along the scanlines and may also influence the thicknesses of the wafer 108 such that the film stress may be inferred from these measurements. In some embodiments, the computing system 106 may be configured to determine the film stress along a particular scanline by using Young's modulus of the substrate of the wafer 108, Poisson's ratio of the substrate, the determined substrate thickness at one or more locations along the particular scanline, the determined film thickness at the one or more locations along the particular scanline, and the determined curvature along the particular scanline. For example, in some embodiments, the film stress may be determined using the following expression:

$$σ = \frac{{ED}^{2}}{6 ( 1 - v ) RT}$$

In the above expression, “σ” may represent the film stress; “E” may represent Young's modulus of the substrate; “D” may represent the substrate thickness; “ν” may represent Poisson's ratio of the substrate; “R” may represent the curvature along the scanline; and “T” may represent the film thickness.

In some embodiments, the computing system 106 may be configured to generate a stress map that may indicate surface stresses with respect to the wafer 108 as a whole. For example, the computing system 106 may be configured to determine surface stresses along various scanlines (e.g., along entire scanlines and/or one or more portions of one or more scanlines) that may be spaced and positioned such that surface stresses at many different areas of the wafer 108 may be determined. An example, is that the computing system 106 may determine surface stresses along 32 different scanlines spaced 5.625° apart such as described above.

In these or other embodiments, the computing system 106 may be configured to perform any suitable interpolation technique with respect to the surface stresses determined at the different locations. The interpolation may provide an estimation and mapping of the surface stresses across the wafer 108 as a whole. Note that as the number of scanlines and/or stress determinations along scanlines increase, the accuracy of the surface stress mapping may increase.

Therefore, the device 100 may be configured to determine film stresses along scanlines based on measured thicknesses and curvatures with respect to the scanlines instead of based on estimations as is done by other systems and devices. Further, the device 100 may be include both the thickness measurement system 102 and the curvature measurement system 104 to enable it to make actual thickness and curvature measurements for film stress determinations. In contrast, other systems and devices may not include both a thickness measurement system and a curvature measurement system. Additionally, the thickness measurement system 102 may provide a large dynamic range; e.g., 5 μm to several mm to substrate thickness measurement as described in U.S. patent application Ser. Nos. 14/260,054 and 12/931,566 incorporated by reference in the present disclosure above.

Modifications, additions, or omissions may be made to FIGS. 1A-1C without departing from the scope of the present disclosure. For example, the device 100 may include more or fewer elements than those illustrated and described in the present disclosure. Additionally, the position of the scanline 110, the configuration of the pattern 120, and/or the positions of the locations 122 may vary depending on different implementations.

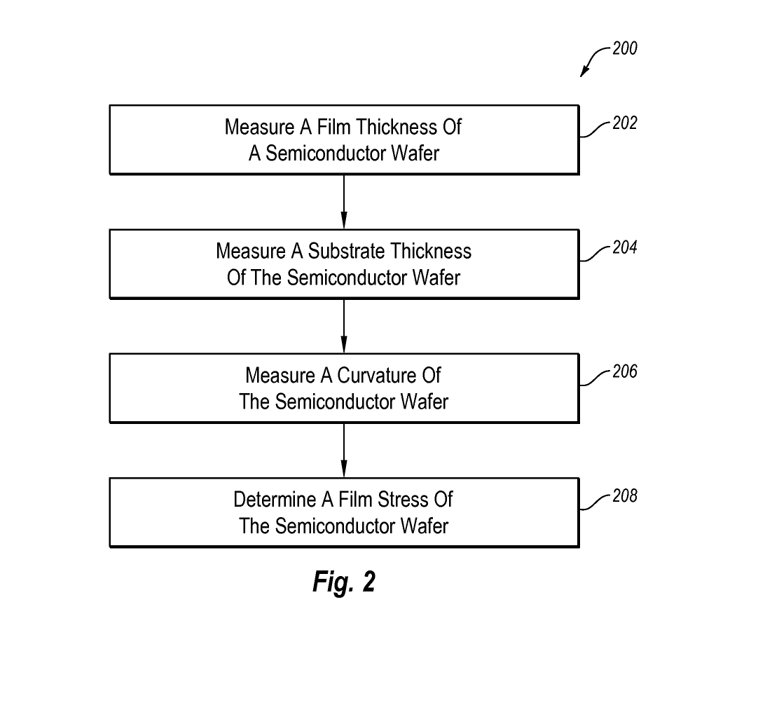

FIG. 2 is a flowchart of an example method 200 of determining film stress, according to at least one embodiment described in the present disclosure. The method 200 may be performed by any suitable system, apparatus, or device. For example, the device 100 of FIG. 1A may be configured to perform one or more of the operations associated with the method 200. Although illustrated with discrete blocks, the steps and operations associated with one or more of the blocks of the method 200 may be divided into additional blocks, combined into fewer blocks, or eliminated, depending on the particular implementation.

The method 200 may begin at block 202, where a film thickness of a semiconductor wafer may be measured. In some embodiments, the film thickness may be measured based on interferometry and may be measured at multiple locations that may be along a scanline of the wafer. In some embodiments, the film thickness may be measured at the locations based on the locations being along the scanline. Additionally or alternatively, the film thickness may be measured according to a pattern that includes the locations and it may be determined that the locations intersect the scanline.

At block 204, a substrate thickness of the semiconductor wafer may be measured. In some embodiments, the substrate thickness may be measured based on interferometry and may be measured at multiple locations that may be along the scanline of the wafer. In some embodiments, the substrate thickness may be measured at the locations based on the locations being along the scanline. Additionally or alternatively, the substrate thickness may be measured according to a pattern that includes the locations and it may be determined that the locations intersect the scanline.

At block 206, a curvature of the semiconductor wafer may be measured. In some embodiments, the curvature may be measured based on an optical measurement technique (e.g., laser triangulation) and may be measured along the scanline of the wafer.

At block 208, a film stress of the semiconductor wafer along the scanline may be determined. In some embodiments, the film stress may be determined based on the measured substrate thickness at the locations, based on the measured film thickness at the locations, and based on the measured curvature along the locations. In some embodiments, the measured substrate thickness at the locations may be averaged and the resulting average may be used in the film stress determination. Additionally or alternatively, the measured film thickness at the locations may be averaged and the resulting average may be used in the film stress determination.

Accordingly, the method 200 may be used to determine film stress of a semiconductor wafer. Modifications, additions, or omissions may be made to the method 200 without departing from the scope of the present disclosure. For example, the operations of method 200 may be implemented in differing order. Additionally or alternatively, two or more operations may be performed at the same time. Furthermore, the outlined operations and actions are only provided as examples, and some of the operations and actions may be optional, combined into fewer operations and actions, or expanded into additional operations and actions without detracting from the essence of the disclosed embodiments. Additionally, although described with respect to a particular scanline, the method 200 may be performed with respect to multiple scanlines that may be at varying locations along the wafer.

In addition, in some embodiments, the method 200 may include one or more operations related to detecting an irregular portion of the semiconductor wafer. In these or other embodiments, the method 200 may include one or more operations related to determining a position of a location of the locations for measuring one or more of the substrate thickness and the film thickness based on detection of the irregular portion such that one or more of the substrate thickness and the film thickness are not measured at the irregular portion

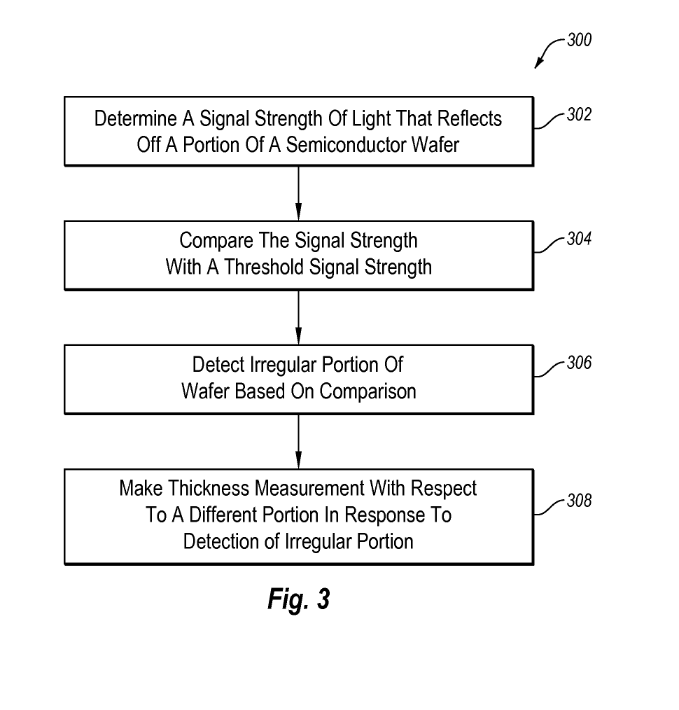

FIG. 3 is a flowchart of an example method 300 of detecting an irregular portion of a semiconductor wafer, according to at least one embodiment described in the present disclosure. The method 300 may be performed by any suitable system, apparatus, or device. For example, the device 100 of FIG. 1A may be configured to perform one or more of the operations associated with the method 300. Although illustrated with discrete blocks, the steps and operations associated with one or more of the blocks of the method 300 may be divided into additional blocks, combined into fewer blocks, or eliminated, depending on the particular implementation.

Further, use of the term “irregular portion” may refer to portions of semiconductors that may create incorrect or incomplete thickness measurements. For example, substrate portions or gridlines of a patterned semiconductor wafer may be considered irregular portions because they may create incorrect or incomplete film thickness measurements. Additionally or alternatively, scatter portions may be considered irregular portions because they may create incorrect or incomplete film or substrate thickness measurements. Also, note that a portion may be considered irregular even if it may not create incomplete thickness measurements with respect to one type of thickness measurement but not another. For example, a substrate portion of a patterned semiconductor wafer may be considered an irregular portion even though it may not create an incorrect or incomplete substrate thickness measurement.

The method 300 may begin at block 302, where a signal strength of light may be determined. The light may include light that reflects off a portion of a semiconductor wafer. In some embodiments, the reflected light may be that used with respect to a particular thickness measurement. The signal strength may be determined using any suitable technique or process. For example, the signal strength may be determined by determining an area under a curve that corresponds to an intensity of the reflected light in the distance domain.

At block 304, the determined signal strength may be compared with a threshold signal strength. In some embodiments, the threshold signal strength may be based on a signal strength that corresponds to an irregular portion as compared to a signal strength that corresponds to a non-irregular portion. In many instances, the signal strength of light that reflects off an irregular portion of a semiconductor wafer may be less than that which reflects off a portion that is not irregular. As such, in some embodiments, the threshold signal strength may correspond to a minimum signal strength of a non-irregular portion. Additionally, the threshold signal strength may be based on the type of irregular portion that may be detected and the type of thickness measurement that corresponds to the reflected light.

At block 306, the irregular portion may be detected based on the comparison of the determined signal strength with the threshold signal strength. The irregular portion may be detected in response to the determined signal strength not satisfying the threshold signal strength. For example, in some embodiments, the irregular portion may be detected in response to the determined signal strength being less than the threshold signal strength in embodiments where the threshold signal strength represents a minimum signal strength for a non-irregular portion

At block 308, a corresponding thickness measurement may be made with respect to a different portion of the semiconductor wafer in response to detection of the irregular portion. In these or other embodiments, the corresponding thickness measurement that may have been made at a portion that includes the irregular portion may be ignored, deleted, or otherwise omitted.

For example, the light whose signal strength may be determined at block 302 may be used for a film thickness measurement. Additionally, based on the operations in blocks 304 and 306, it may be determined that the film thickness measurement was taken at an irregular portion. Accordingly, at block 308, the film thickness measurement may be performed on a different portion of the semiconductor wafer in response to detecting the irregular portion. In these or other embodiments, the film thickness measurement that may be obtained at the portion that includes the irregular portion may be ignored, deleted, or otherwise omitted in response to detecting the irregular portion.

Accordingly, the method 300 may be used to detect one or more irregular portions of a semiconductor wafer. Modifications, additions, or omissions may be made to the method 300 without departing from the scope of the present disclosure. For example, the operations of method 300 may be implemented in differing order. Additionally or alternatively, two or more operations may be performed at the same time. Furthermore, the outlined operations and actions are only provided as examples, and some of the operations and actions may be optional, combined into fewer operations and actions, or expanded into additional operations and actions without detracting from the essence of the disclosed embodiments.

As indicated above, the embodiments described in the present disclosure may include the use of a special purpose or general purpose computer including various computer hardware or software modules, as discussed in greater detail below. Further, as indicated above, embodiments described in the present disclosure may be implemented using computer-readable media for carrying or having computer-executable instructions or data structures stored thereon.

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated. In this description, a “computing entity” may be any computing system as previously defined in the present disclosure, or any module or combination of modulates running on a computing system.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases at least one and one or more to introduce claim recitations. However, the use of such phrases should not be construed to imply that the introduction of a claim recitation by the indefinite articles “a” or an limits any particular claim containing such introduced claim recitation to embodiments containing only one such recitation, even when the same claim includes the introductory phrases one or more or at least one and indefinite articles such as “a” or an (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

All examples and conditional language recited in the present disclosure are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

What is claimed is:

1. A method comprising:
measuring, based on interferometry, a film thickness of a surface film of a semiconductor wafer at a plurality of locations that are along a scanline of the wafer;
measuring, based on interferometry, a substrate thickness of a substrate of the semiconductor wafer at the plurality of locations;
measuring, based on an optical measurement technique, a curvature of the semiconductor wafer along the scanline; and
determining a stress of the surface film along the scanline based on the measured film thickness at the plurality of locations, based on the measured substrate thickness at the plurality of locations, and based on the measured curvature along the scanline.

2. The method of claim 1, wherein the method further comprises:
detecting an irregular portion of the semiconductor wafer; and
determining a position of a location of the plurality of locations for measuring one or more of the substrate thickness and the film thickness based on detection of the irregular portion such that one or more of the substrate thickness and the film thickness are not measured at the irregular portion.

3. The method of claim 2, wherein detecting the irregular portion includes:
determining a signal strength of light reflected from a portion of the wafer; and
detecting that the portion includes the irregular portion based on the determined signal strength not satisfying a threshold signal strength.

4. The method of claim 3, wherein determining the signal strength further comprises determining an area under a curve that corresponds to an intensity of light reflected off the wafer in a distance domain.

5. The method of claim 2, wherein the irregular portion includes one or more of a substrate portion, a gridline, and a scatter portion of the semiconductor wafer.

6. The method of claim 1, further comprising measuring the film thickness and the substrate thickness at the plurality of locations based on the plurality of locations being along the scanline.

7. The method of claim 1, further comprising measuring one or more of the film thickness and the substrate thickness according to a pattern that includes the plurality of locations and determining that the plurality of locations intersect the scanline.

8. The method of claim 1, further comprising averaging the film thickness and the substrate thickness with respect to the plurality of locations and determining the stress based on resulting averages.

9. A device comprising:
a thickness measurement system configured to:
measure, based on interferometry, a film thickness of a surface film of a semiconductor wafer at a plurality of locations that are along a scanline of the wafer; and
measure, based on interferometry, a substrate thickness of a substrate of the semiconductor wafer at the plurality of locations;
a curvature measurement system configured to measure, based on an optical measurement technique, a curvature of the semiconductor wafer along the scanline; and
a computing system configured to determine a stress of the surface film along the scanline based on the measured film thickness at the plurality of locations, based on the measured substrate thickness at the plurality of locations, and based on the measured curvature along the scanline.

10. The device of claim 9, wherein the computing system is further configured to:
detect an irregular portion of the semiconductor wafer; and
determine a position of a location of the plurality of locations for measuring one or more of the substrate thickness and the film thickness based on detection of the irregular portion such that one or more of the substrate thickness and the film thickness are not measured at the irregular portion.

11. The device of claim 10, wherein detecting the irregular portion includes:
determining a signal strength of light reflected from a portion of the wafer; and
detecting that the portion includes the irregular portion based on the determined signal strength not satisfying a threshold signal strength.

12. The device of claim 11, wherein determining the signal strength further comprises determining an area under a curve that corresponds to an intensity of light reflected off the wafer in a distance domain.

13. The device of claim 10, wherein the irregular portion includes one or more of a substrate portion, a gridline, and a scatter portion of the semiconductor wafer.

14. The device of claim 9, wherein the computing system is further configured to direct the thickness measurement system to measure one or more of the film thickness and the substrate thickness at the plurality of locations based on the plurality of locations being along the scanline.

15. The device of claim 9, wherein the computing system is further configured to direct the thickness measurement system to measure one or more of the film thickness and the substrate thickness according to a pattern that includes the plurality of locations and determining that the plurality of locations intersect the scanline.

16. The device of claim 9, wherein the computing system is further configured to average the film thickness and the substrate thickness with respect to the plurality of locations and to determine the stress based on resulting averages.

17. Computer-readable storage media including computer-executable instructions configured to cause a device to perform operations, the operations comprising:
measuring, based on interferometry, a film thickness of a surface film of a semiconductor wafer at a plurality of locations that are along a scanline of the wafer;
measuring, based on interferometry, a substrate thickness of a substrate of the semiconductor wafer at the plurality of locations;
measuring, based on an optical measurement technique, a curvature of the semiconductor wafer along the scanline; and
determining a stress of the surface film along the scanline based on the measured film thickness at the plurality of locations, based on the measured substrate thickness at the plurality of locations, and based on the measured curvature along the scanline.

18. The computer-readable storage media of claim 17, wherein the operations further comprise:
detecting an irregular portion of the semiconductor wafer; and
determining a position of a location of the plurality of locations for measuring one or more of the substrate thickness and the film thickness based on detection of the irregular portion such that one or more of the substrate thickness and the film thickness are not measured at the irregular portion.

19. The computer-readable storage media of claim 17, wherein the operations further comprise measuring the film thickness and the substrate thickness at the plurality of locations based on the plurality of locations being along the scanline.

20. The computer-readable storage media of claim 17, wherein the operations further comprise measuring one or more of the film thickness and the substrate thickness according to a pattern that includes the plurality of locations and determining that the plurality of locations intersect the scanline.

21. The computer-readable storage media of claim 17 wherein the operations further comprise generating a stress map using substrate thickness, film thickness and wafer curvature data generated from each scan line.
